(19) United States
(12) Patent Application Publication
(10) Pub. No.: US 2023/0117618 A1
(43) Pub. Date: Apr. 20, 2023

(54) Oral Supplement to Trigger Repair Of Organs

(71) Applicant: Johnson Consulting, LLC, San Juan, PR (US)

(72) Inventor: Benjamin Johnson, Evergreen, CO (US)

(21) Appl. No.: 17/451,419

(22) Filed: Oct. 19, 2021

(51) Int. Cl. A23L 33/175; A23L 33/18

(52) U.S. Cl. CPC A23L 33/175; A23L 33/18

(57) ABSTRACT

A novel supplement is disclosed which triggers repair of organs in humans, including the liver, kidneys, lungs, and skin. The example supplement includes a combination of alpha ketoglutarate (AKG). The example supplement also includes select amino acids. The example supplement also includes extract components found in an organ being treated. The AKG activates hydroxylation of the select amino acids and micronutrients, cytokines, and peptides in the extract components to accelerate a natural repair process of the organ being treated. In an example, the amino acids include 3 or more of any combination of: glutamine, isoleucine, leucine, lysine, methionine, phenylalanine, tyrosine, threonine, tryptophan, valine, histidine, proline, glycine, and arginine.

### BACKGROUND

Researchers and physicians have been attempting to solve the challenges of many conditions by using medications that target suspected bacterial infections like antibiotics or by treating presumed immune system irregularities (excess inflammation) with immunomodulators or steroids. These options come with health consequences and side effects and often do not result in a successful outcome.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1-12 are photographs illustrating various skin conditions before treatment and after treatment according to the techniques described herein.

### DETAILED DESCRIPTION

It is known that in many countries around the world, the average person is exposed to approximately one million toxins a day. Exposure may occur through ingestion, inhalation, and even topically (e.g., through the skin). Organs, such as the liver, kidneys, lungs, and even the skin, all work as detoxifying organs to remove toxins from the human body. As a result, these organs often become damaged over time beyond typical cellular aging. This damage to the organs can cause the body to accumulate toxins in fat cells and elsewhere, causing weight gain, reduced immunity, reduced blood oxygen levels, and other health issues.

A novel supplement is disclosed herein which triggers repair of organs in humans, including the liver, kidneys, lungs, and even skin. In an example, the supplement includes a unique combination of ingredients that, when presented together, trigger substantial repair of various organs.

In an example, the supplement includes a combination of alpha ketoglutarate (AKG). The example supplement also includes select amino acids. The example supplement also includes extract components found in an organ being treated. The AKG activates hydroxylation of the select amino acids and micronutrients, cytokines and peptides in the extract components to accelerate a natural repair process of the organ being treated.

In an example, the amino acids include 3 or more of any combination of: glutamine, isoleucine, leucine, lysine, methionine, phenylalanine, tyrosine, threonine, tryptophan, valine, histidine, proline, glycine, and arginine.

Benefits of a treatment regimen include, but are not limited to, improved immune response, improved of fatty liver disease and cirrhosis of the liver, healing of liver spots, skin wrinkles, skin redness and melasma on the skin, weight loss, improved oxygenation, improved thyroid function, reduced hair loss, weight loss and improved cognition.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

An example of the supplement includes a combination of alpha ketoglutarate (AKG). The example supplement also includes select amino acids. The example supplement also includes extract components found in an organ being treated. When taken as a supplement (e.g., oral ingestion), the AKG activates hydroxylation of the select amino acids and micronutrients, cytokines, and peptides in the extract components to accelerate a natural repair process of the organ being treated.

It is noted that the supplement may be taken orally, e.g., as a capsule or as a powder mixed with food and/or water or other liquid. The supplement may also be administered as part of an IV or any other effective means for administering.

In an example, the amino acids include 3 or more of any combination of: glutamine, isoleucine, leucine, lysine, methionine, phenylalanine, tyrosine, threonine, tryptophan, valine, histidine, proline, glycine, and arginine.

In an example, each amino acid of the supplement is between about 1-200 mg. In another example, each amino acid is between about 5-200 mg daily. Also in an example, the AKG is between about 10-200 mg daily. In another example, the AKG is between about 50-100 mg daily. In an example, the dosing is substantially daily for at least about 3 to 12 months. It is noted that the dosing described herein were observed to optimize a treatment regimen. The amounts may be provided as a single dose (e.g., capsule or powder), or as multiple doses (e.g., capsule or powder) to provide the desired dosing, as is common with supplement dosing.

AKG is an important part of the Krebs cycle, and also plays a role in the hydroxylation of amino acids necessary for collagen and elastin production as well as many repair activities in the human body. It has been observed that the combination of unique extract components and the specific blend of amino acids and AKG results in a significant increase in the repair of many organs.

AKG is known to improve blood flow in surgeries but has little other clinical evidence of efficacy on its own or paired with other ingredients. It is the partnership with micronutrients, cytokines, and peptides in the liver extract components and/or amino acids that accelerates specific organ repair. Example extract components which may be provided along with the AKG for treatment of various conditions follow by way of illustration.

Example extract components for treatment of the liver include, but are not limited to, threonine, tryptophan, valine, histidine, proline, glycine, and arginine.

Example extract components for treatment of the lungs include, but are not limited to, valine, histidine, and arginine.

Example extract components for treatment of the brain include, but are not limited to, methionine, phenylalanine, tyrosine, threonine, tryptophan, valine, and histidine.

Example extract components for treatment of the kidneys include, but are not limited to, glutamine, isoleucine, leucine, tyrosine, threonine, tryptophan, and valine.

Example extract components for treatment of the thyroid include, but are not limited to, Thyroid: glutamine, isoleucine, leucine, and valine.

Example extract components for treatment of the skin include, but are not limited to, isoleucine, leucine, lysine, tyrosine, threonine, proline, glycine.

In an example, the supplement may include a buffering agent to protect active components of the supplement against stomach acidity prior to absorption into the bloodstream.

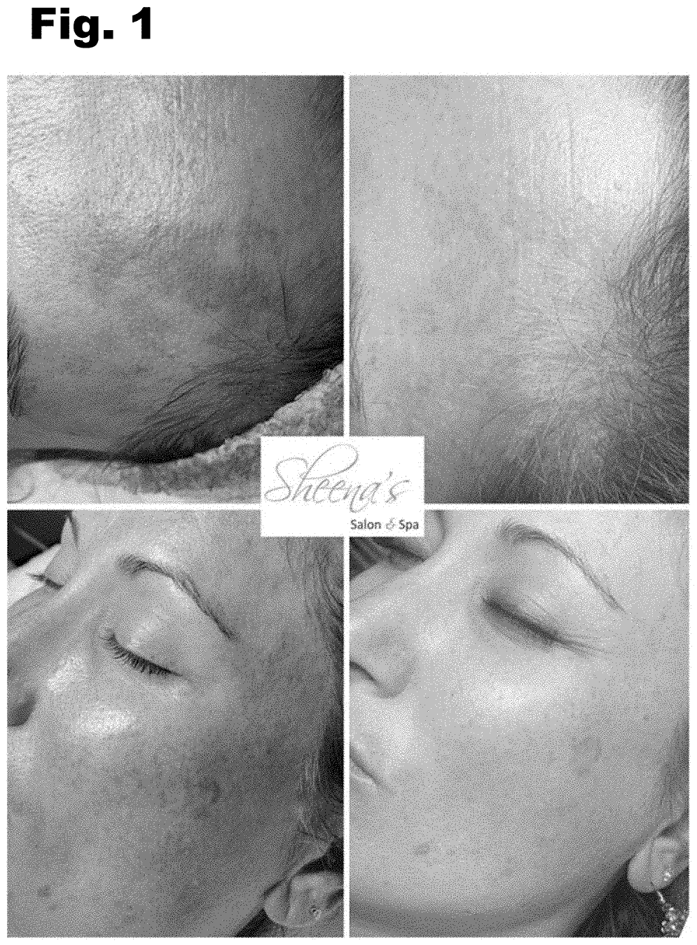

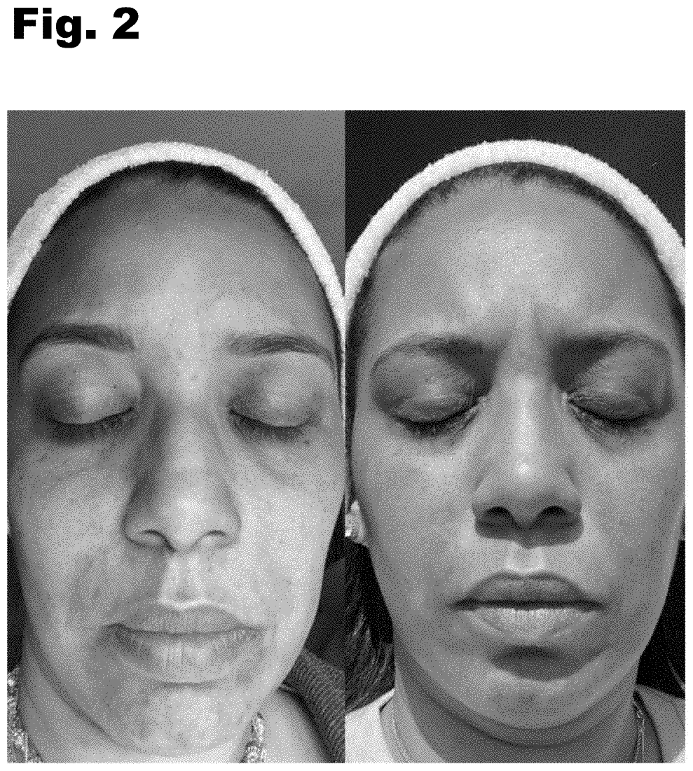

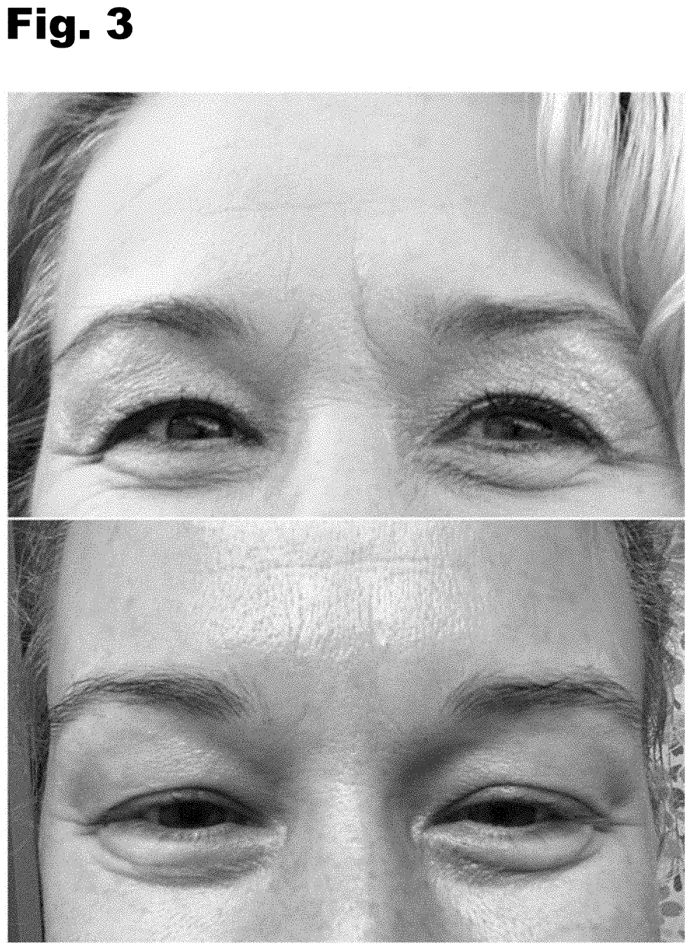

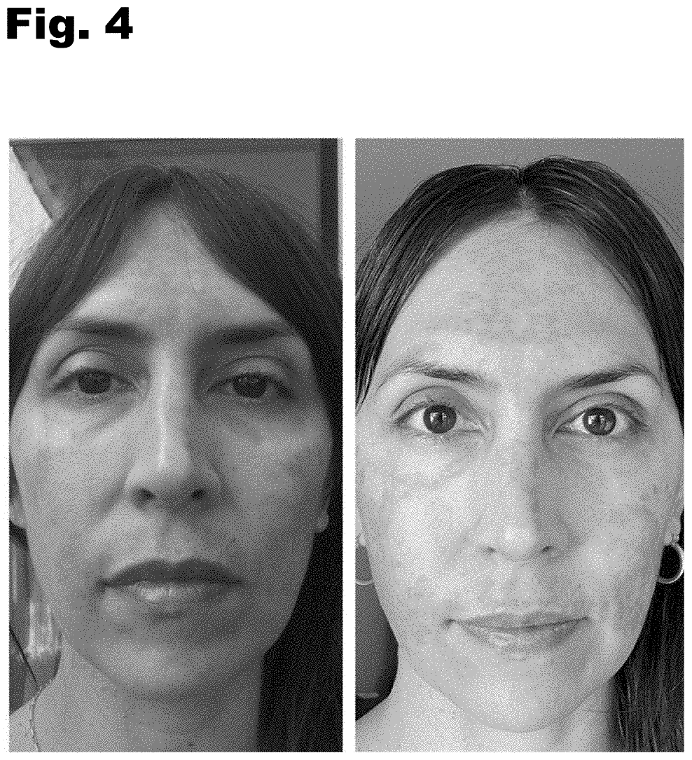

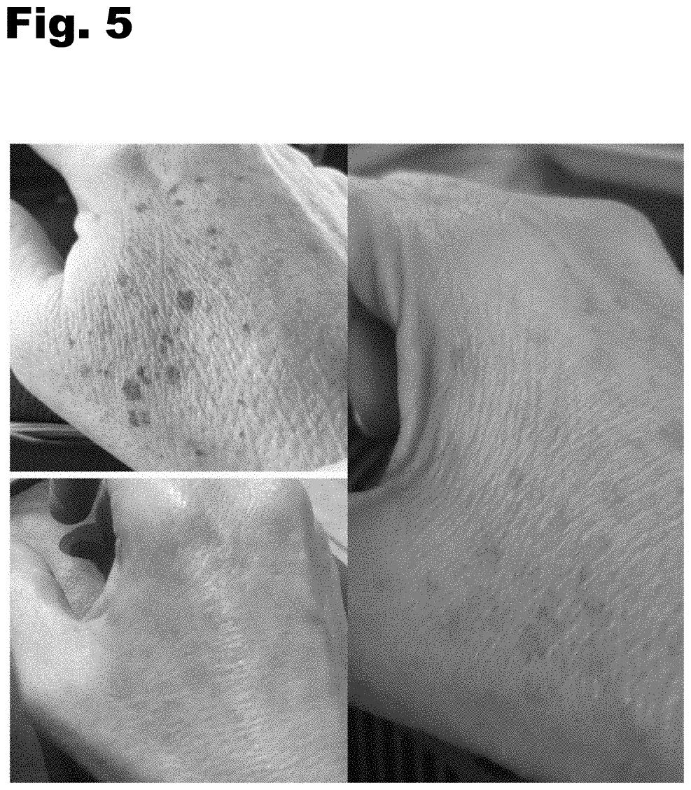

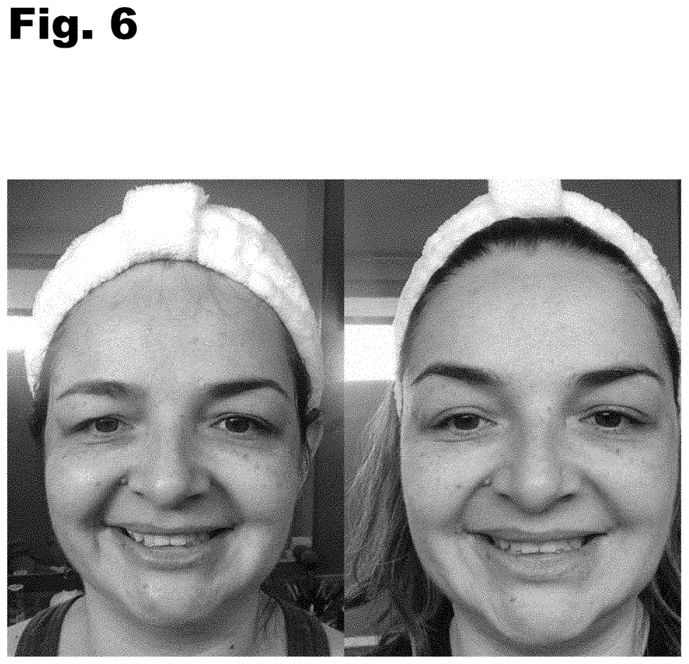

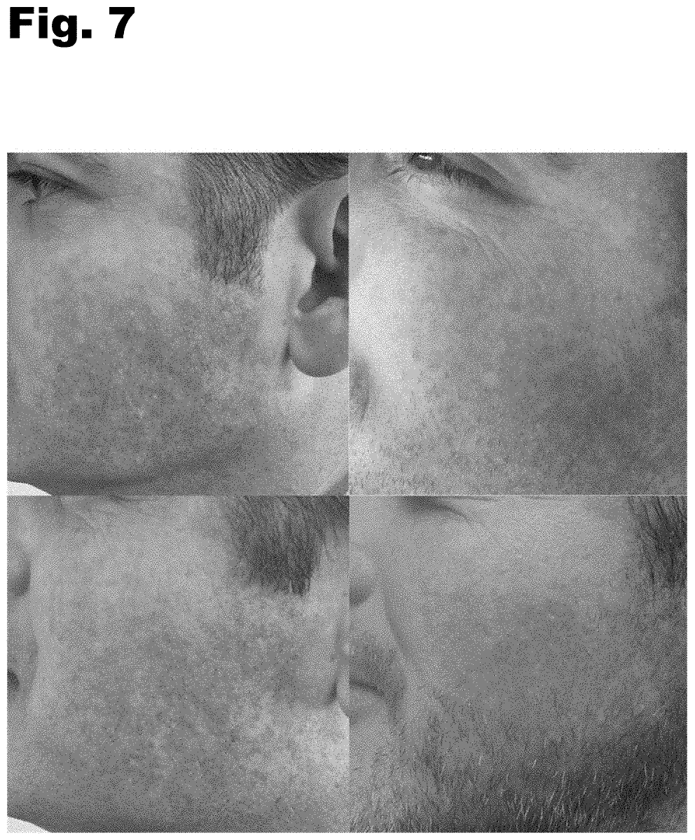

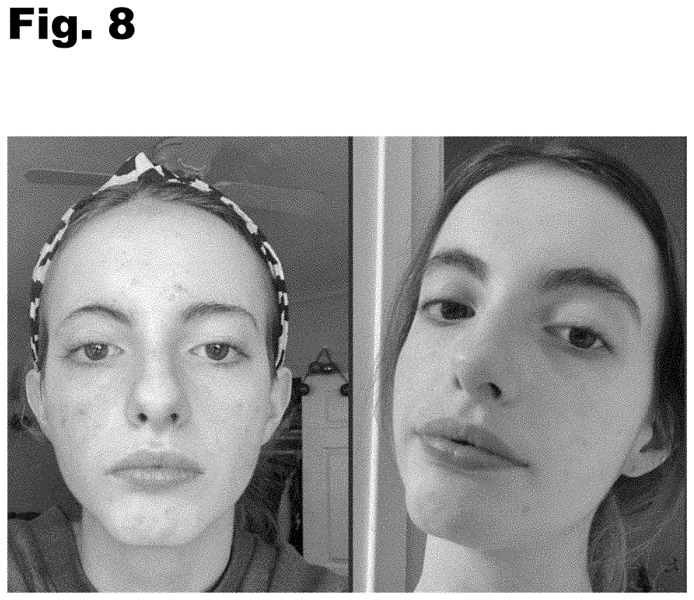

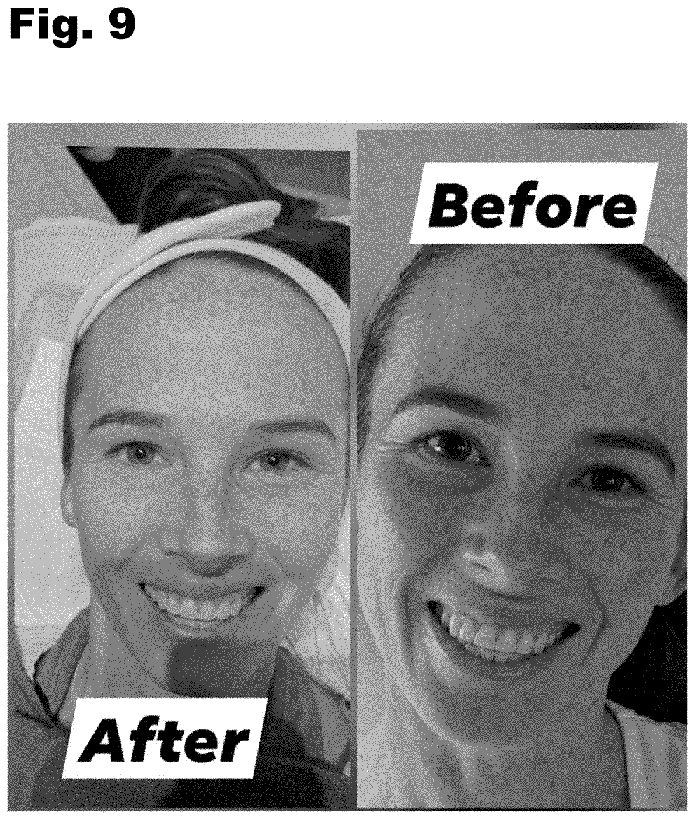

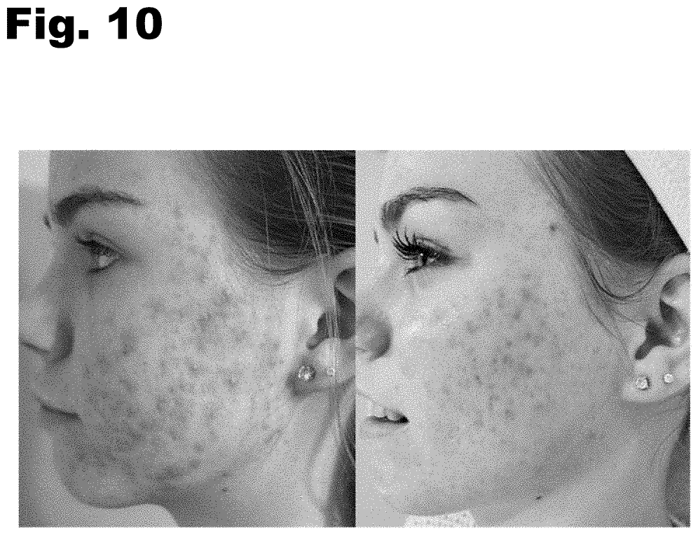

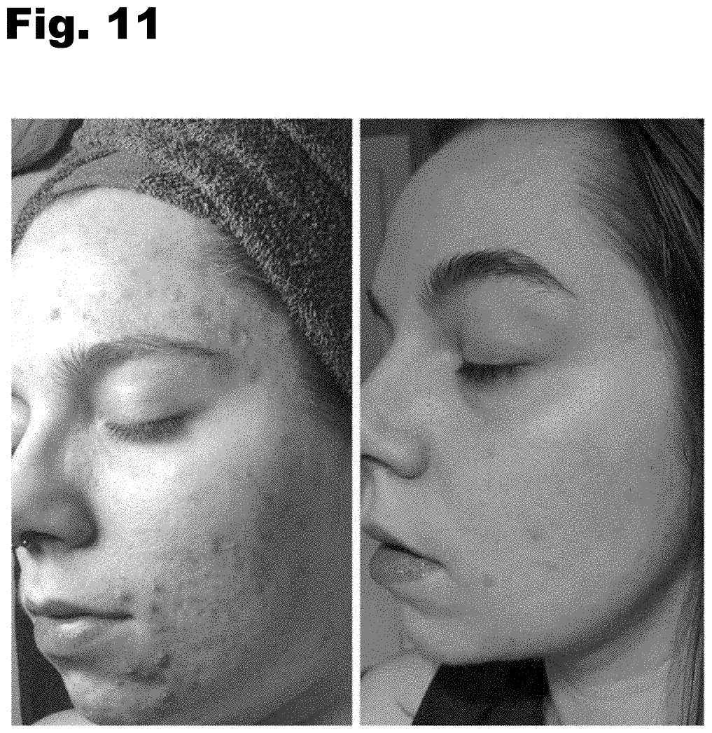

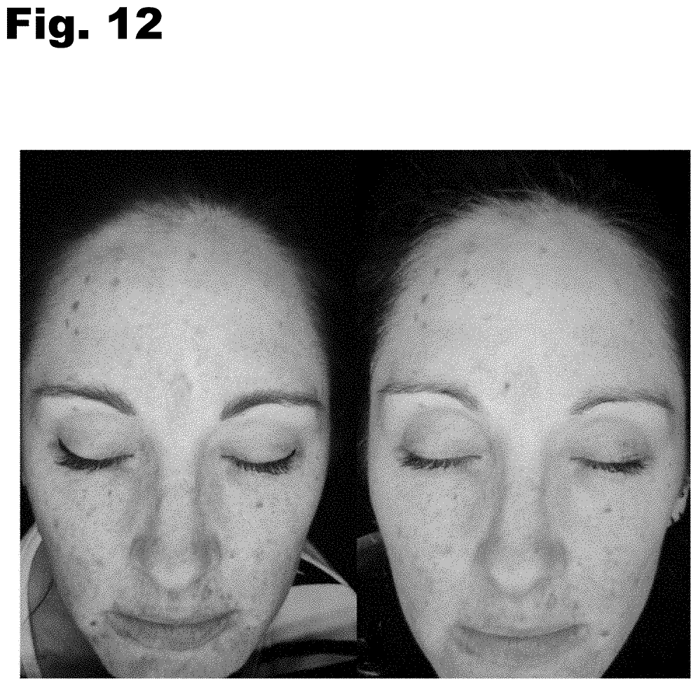

A novel supplement is disclosed herein which triggers repair of organs in humans, including the liver, kidneys, lungs, and even skin and conditions thereof. FIGS. 1-12 are photographs illustrating various skin conditions before treatment and after treatment according to the techniques described herein. These photographs are provided for purposes of illustration of treatment regimens.

Amino acids have been used in skincare to improve the skin's appearance but their effects have been limited. Additionally, Vitamin C plays a role in hydroxylation, a key step in the formation of collagen and elastin. However, it is a novel concept to activate high levels of hydroxylation of amino acids by combining the two components together in a supplement. The AKG has different effects on the skin when used in higher doses. Visible changes to fine lines and wrinkles have been observed by taking this combination as part of the supplement, as shown in the drawings.

It is noted, however, that the supplement is not limited to use for treatment of the skin and skin conditions. The supplement and treatment regimens described herein may be provided treatment of a variety of organs and related conditions. Indeed, the supplement and treatment regimens may affect more than one organ at a time, such as treating a liver condition may also treat an associated or even a different skin condition (e.g., a skin condition that is unrelated to the organ being treated).

Indeed, treatment of organs via the supplement may also result in weight loss. The liver's connection to weight gain has not received a great amount of attention. However, fat cell accumulation of toxins is a large contributor to weight gain. By repairing the liver, the toxins are dismantled and do not have to be moved to the fat cells for storage. This results in weight loss. In addition, a healthier liver processes carbohydrates more efficiently leading to weight loss under certain dietary conditions. Accordingly, use of the supplement may lead to weight loss.

As noted above, the supplement may be administered as part of a treatment regimen to repair organ damage. In an example, the supplement is specific to trigger repair of the liver. The role of a healthy liver in immunity is undisputed. The supplement treats and even repairs old damage to the liver, thus improving the overall health of the liver and related conditions. While “liver spots” are often considered a colloquial term, these do in fact occur as a result of liver damage. For example, melasma is a pigmented skin condition that is poorly understood. However, there is evidence that this comes from damage to the liver, often caused by elevated hormones and/or medications. The supplement has been successfully administered as part of a treatment regimen to expedite healing of the liver, resulting in a clearance at the skin level, as seen in the drawings.

In this example, the example supplement may include a combination of alpha ketoglutarate (AKG). The example supplement may also include select amino acids. The example supplement may also include liver extract. The AKG activates hydroxylation of the select amino acids and, in combination with micronutrients, cytokines, and peptides in the components of the liver extract, accelerates a natural repair process of the liver.

In an example, the liver extract includes dessicated liver extract. In another example, the liver extract includes bovine liver extract. In another example, the liver extract includes un-defatted liver extract.

It is believed that the mechanism of action is based on the novel use of AKG to activate through the hydroxylation of select amino acids in combination with the micronutrients in the components within the liver extract. Components found in bovine liver are very similar to what is found in the human liver, and thus provide needed supplies of micronutrients, cellular cytokines, and peptides related liver repair.

The benefits of taking liver extract are based on the presence of folic acid, glutathione, B-12, B-6, iron, choline, copper, Vitamin A, minerals and essential amino acids. None of these have shown specific benefits when liver extract is taken on its own. However, the effects of the combination treatment provided as the supplement described herein have produced uniquely exceptional results.

It is noted that the examples shown and described are provided for purposes of illustration and are not intended to be limiting. Still other examples are also contemplated.

1. A dietary supplement which triggers repair of organs in humans, including the liver, kidneys, lungs, and even skin, comprising:
a combination of alpha ketoglutarate (AKG);
select amino acids; and
extract components found in an organ being treated;
wherein the AKG activates hydroxylation of the select amino acids and the extract components to provide cellular cytokines, micronutrients, and peptides, to accelerate a natural repair process of the organ being treated.

2. The dietary supplement of claim 1, wherein the extract components include dessicated liver extract.

3. The dietary supplement of claim 1, wherein the extract components include bovine liver extract.

4. The dietary supplement of claim 1, wherein the extract components include un-defatted liver extract.

5. The dietary supplement of claim 1, wherein the amino acids include 3 or more of any combination of: glutamine, isoleucine, leucine, lysine, methionine, phenylalanine, tyrosine, threonine, tryptophan, valine, histidine, proline, glycine, and arginine.

6. The dietary supplement of claim 5, wherein each amino acid is between about 1-200 mg daily for at least about 3 to 12 months.

7. The dietary supplement of claim 5, wherein each amino acid is between about 5-200 mg daily for at least about 3 to 12 months.

8. The dietary supplement of claim 1, wherein the AKG is between about 10-200 mg daily for at least about 3 to 12 months.

9. The dietary supplement of claim 1, wherein the AKG is between about 50-100 mg daily for at least about 3 to 12 months.

10. The dietary supplement of claim 1, further comprising a buffering agent to protect active components of the supplement against stomach acidity.

11. The dietary supplement of claim 1, further comprising extract components for treatment of the liver, including at least threonine, tryptophan, valine, histidine, proline, glycine, and arginine.

12. The dietary supplement of claim 1, further comprising extract components for treatment of the lungs, including at least valine, histidine, and arginine.

13. The dietary supplement of claim 1, further comprising extract components for treatment of the brain, including at least methionine, phenylalanine, tyrosine, threonine, tryptophan, valine, and histidine.

14. The dietary supplement of claim 1, further comprising extract components for treatment of the kidneys, including at least glutamine, isoleucine, leucine, tyrosine, threonine, tryptophan, and valine.

15. The dietary supplement of claim 1, further comprising extract components for treatment of the thyroid, including at least glutamine, isoleucine, leucine, and valine.

16. The dietary supplement of claim 1, further comprising extract components for treatment of the skin, including at least isoleucine, leucine, lysine, tyrosine, threonine, proline, and glycine.

17. A dietary supplement which triggers repair of liver and associated skin conditions, comprising:
a combination of alpha ketoglutarate (AKG);
select amino acids including 3 or more of any combination of: glutamine, isoleucine, leucine, lysine, methionine, phenylalanine, tyrosine, threonine, tryptophan, valine, histidine, proline, glycine, and arginine; and
liver extract;
wherein the AKG activates hydroxylation of the select amino acids and micronutrients, cytokines, and peptides in the liver extract to accelerate a natural repair process of the liver.

18. The dietary supplement of claim 17, wherein the liver extract includes dessicated liver extract.

19. The dietary supplement of claim 17, wherein the liver extract includes bovine liver extract.

20. The dietary supplement of claim 17, wherein the liver extract includes un-defatted liver extract.
